(19) United States
(12) Patent Application Publication
(10) Pub. No.: US 2013/0235558 A1
(43) Pub. Date: Sep. 12, 2013

(54) AWNING ROLL ATTACHMENT WITH ILLUMINATION AND MIST

(71) Applicant: Wei Zhou, Granger, IN (US)

(72) Inventor: Wei Zhou, Granger, IN (US)

(21) Appl. No.: 13/416,986

(22) Filed: Mar. 9, 2012

(51) Int. Cl. B05B 3/00; F21V 33/00

(52) U.S. Cl. 362/96; 239/208

(57) ABSTRACT

An awning roll attachment that mounts directly to the awning roll and includes an internal illumination system and misting system. The awning roll attachment is connected to a roll tube using a press fit connection. The illumination system includes a light strip that is seated or embedded within a longitudinal channel formed in the attachment body. The misting system includes a plurality of misting nozzles that are tapped into bores in the attachment body and are in open communication with an internal fluid passage formed in the attachment body that runs its entire length. A connection fitting is connected to the fluid passage at one end of the attachment body and an end plug closes the fluid passage at the opposite end of the attachment body.

This invention relates to a retractable awning and particularly an awning roll attachment that provides illumination and mist.

### BACKGROUND AND SUMMARY OF THE INVENTION

Retractable (roll-up) awnings are common features on a variety of buildings and recreational vehicles. Roll-up awnings provide shade and protection from wind and rain. It is also common for valances, mosquito nets, lights and other items to be suspended from the awning rolls and support members. Typically, awning rolls have a plurality of longitudinal grooves that are used to secure the awning fabric to the roll, but are also used to support valances and other items suspended from the rolls. While specialized hangers and clips have been developed to assist in suspending such items from an awning roll, hanging such items often create a cluttered appearance, which detracts from the appearance and enjoyment of the awning.

The present invention provides an awning roll attachment that mounts directly to the awning roll and includes an internal illumination system and misting system. The awning roll attachment has an elongated body with a concave rear face, which conforms generally to the curvature of the outer diameter of an awning roll tube. An attachment tab extends from the rear surface of the roll attachment, which allows it to be secured to the roll tube using a press fit connection. The illumination system includes a strip of light emitting diodes (LED light strip) or a rope light that is seated within a longitudinal channel formed in an attachment body and is visible through a longitudinal slot that opens into the channel. A power cord connects the embedded LED light strip or rope light to an external power supply. The misting system includes a plurality of misting nozzles that are tapped into bores in the attachment body and are in open communication with an internal fluid passage formed in the attachment body running its entire length. A connection fitting is connected to the fluid passage at one end of the attachment body and an end plug closes the fluid passage at the opposite end of the attachment body. A hose connects an external water supply to the misting system.

This invention also includes a storage mounting bracket, which securely holds the awning attachment to a wall, providing a convenient storage mechanism for the attachment when not in use. The combination of the awning attachment and storage mounting bracket of this invention provides a convenient and aesthetically clean appearance to the retractable awning, while also providing illumination and misting. The awning attachment eliminates dangling cords and waterlines along with the clips and hangers used to support those cords and waterlines from the roll tube. The storage mounting brackets provide a convenient and readily accessible storage mechanism, allowing the awning attachment to be stored against a sidewall, so that the storage of the attachment does not occupy other valuable storage space.

The above described features and advantages, as well as others, will become more readily apparent to those of ordinary skill in the art by reference to the following detailed description and accompanying drawings.

### BRIEF DESCRIPTION OF THE DRAWINGS

The present invention may take form in various system and method components and arrangements of system and method components. The drawings are only for purposes of illustrating exemplary embodiments and are not to be construed as limiting the invention. The drawings illustrate the present invention, in which:

FIG. 1 is a perspective view of an embodiment of the roll attachment of this invention attached to the awning roll of a conventional roll-up awning;

FIG. 2 is an exploded view of the roll attachment and roll-up awning of FIG. 1;

FIG. 3 is side sectional view of the roll attachment and roll-up awning of FIG. 1;

FIG. 4 is a partial exploded perspective view of the roll attachment of FIG. 1 and a mounting bracket affixed to the side of a recreational vehicle;

FIG. 5 is a partial exploded perspective view of the roll attachment of FIG. 1 connected to the mounting bracket of FIG. 4;

FIG. 6 is a side view of the side of a recreational vehicle showing a roll-up awning in the rolled out position with the roll attachment of FIG. 1 attached to the awning roll and the mounting bracket of FIG. 4 affixed to the side of a recreational vehicle;

FIG. 7 is a side view of the side of a recreational vehicle showing a roll-up awning in the rolled up position with the roll attachment of FIG. 1 attached to the mounting bracket of FIG. 4 affixed to the side of a recreational vehicle;

FIG. 8 is a side view of the side of a recreational vehicle showing a roll-up awning in the rolled up position with the roll attachment of FIG. 1 still attached to the awning roll; and

FIG. 9 is a partial perspective view of an alternative embodiment of the roll attachment of this invention.

### DESCRIPTION OF THE PREFERRED EMBODIMENT

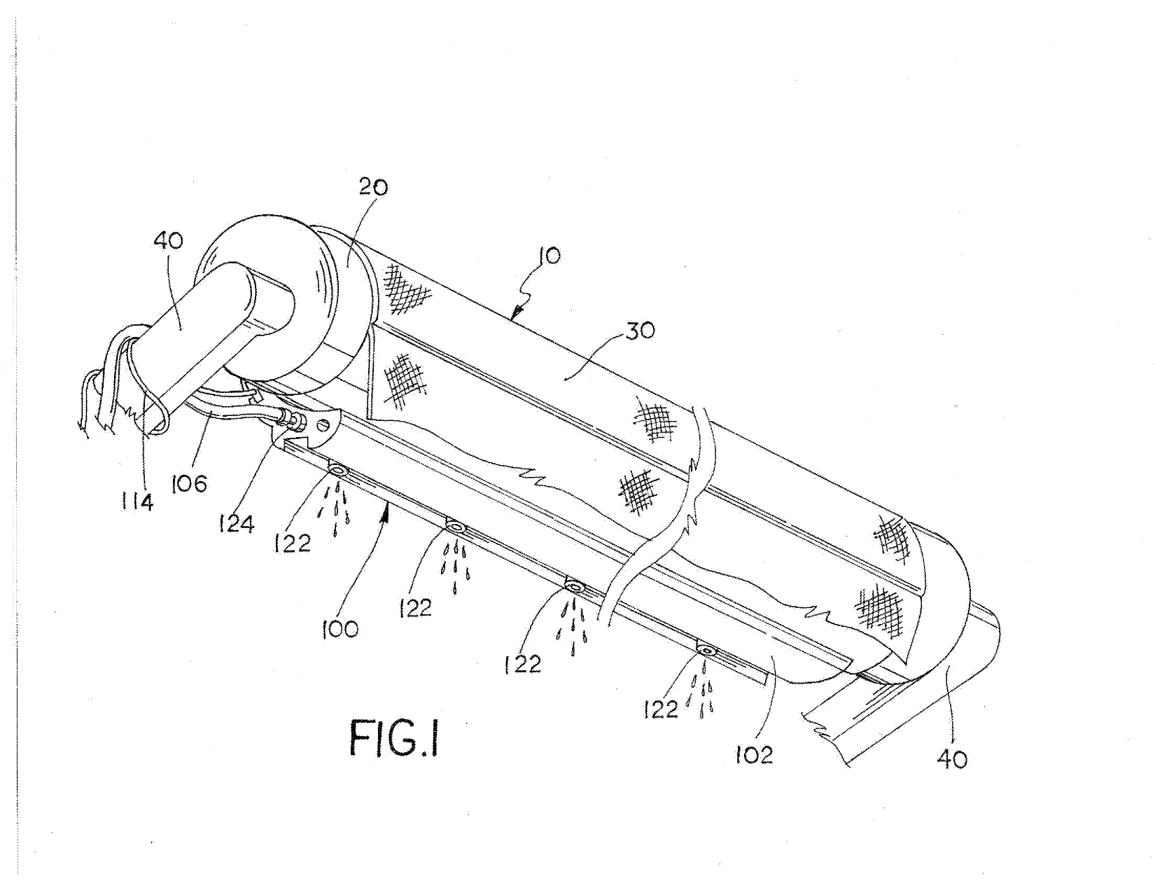

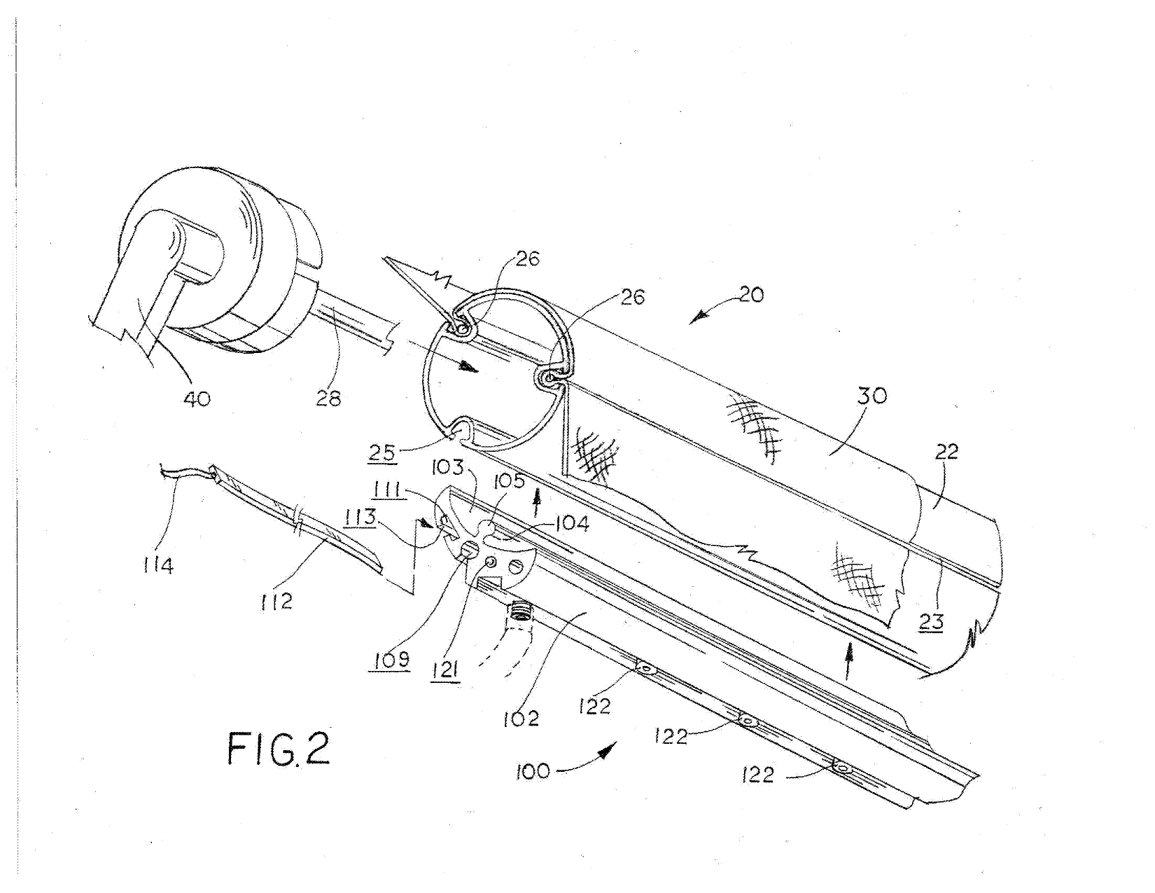

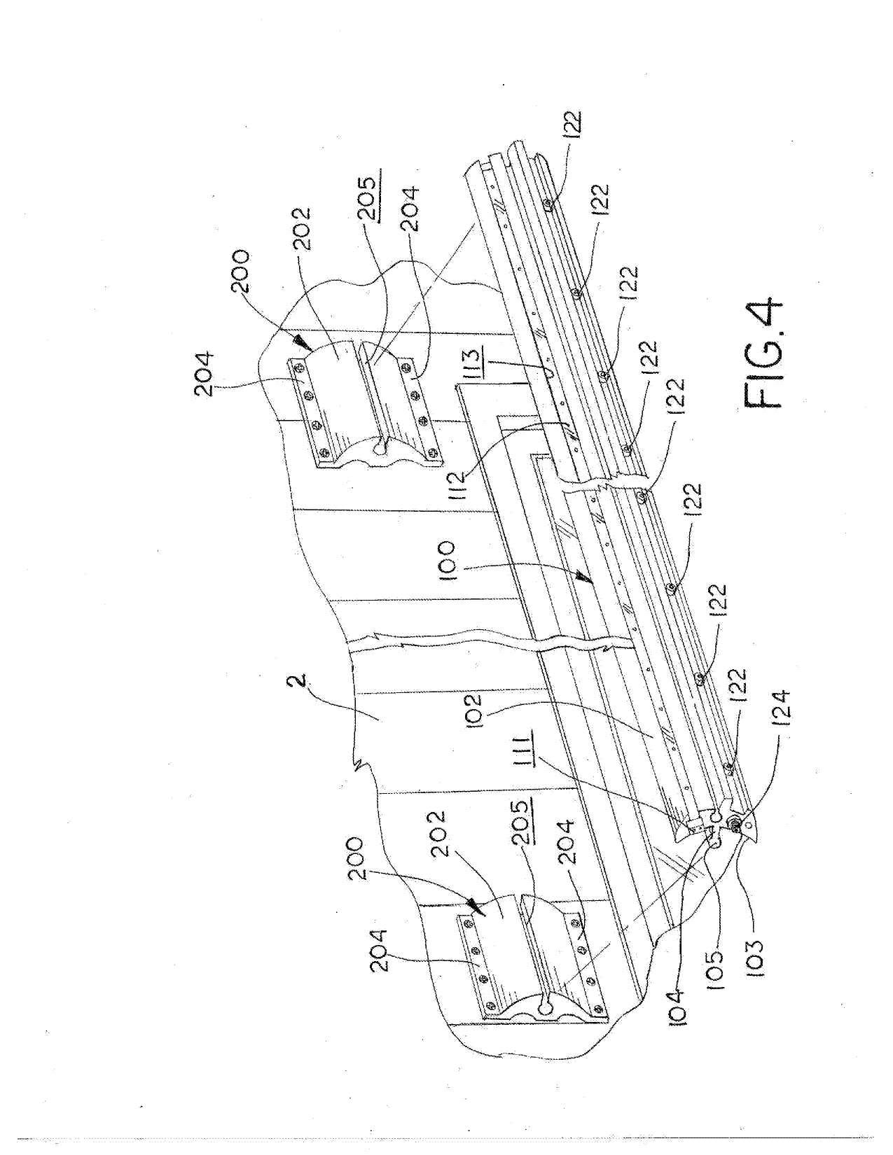

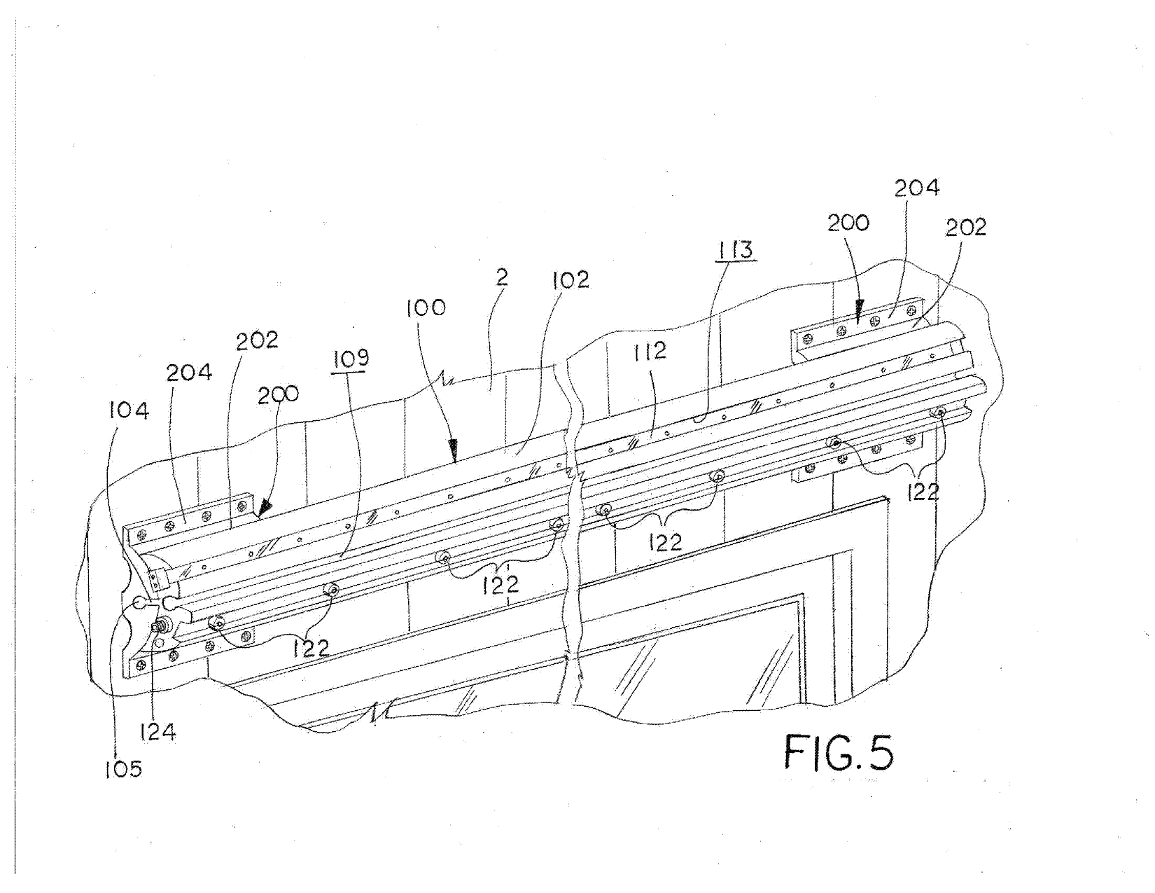

Referring now to the drawings, FIGS. 1-7 illustrate an embodiment of the awning roll attachment of this invention, which is designated generally as reference numeral 100 and its accompanying storage mounting brackets, which are designated generally as reference numerals 200. For simplicity of illustration and explanation, awning attachment 10 is shown and described herein used in conjunction with a conventional retractable (roll-up) awning 10 mounted to a recreational vehicle (partially illustrated in FIGS. 4-7). Attachment 100 may be adapted for use with any retractable awning that includes an awning roll tube having an available longitudinal accessory groove.

### Retractable Awning

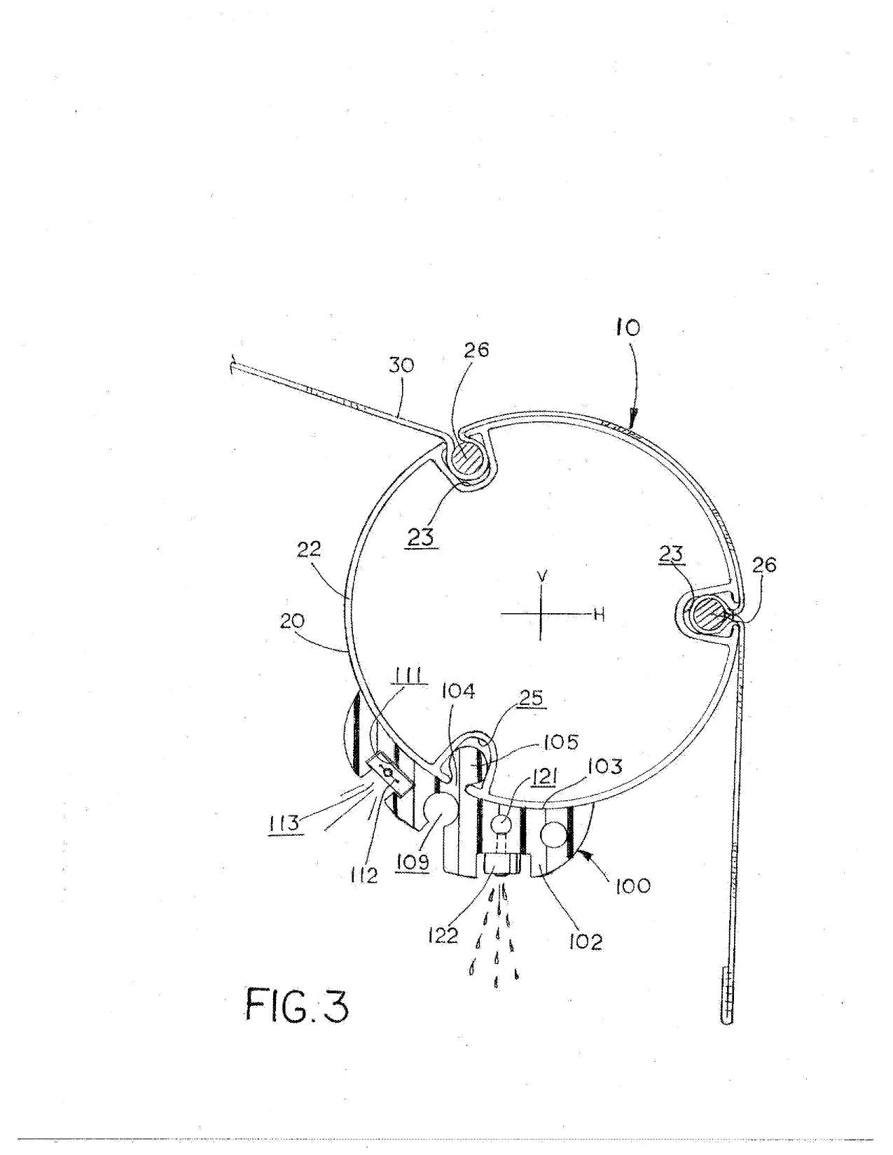

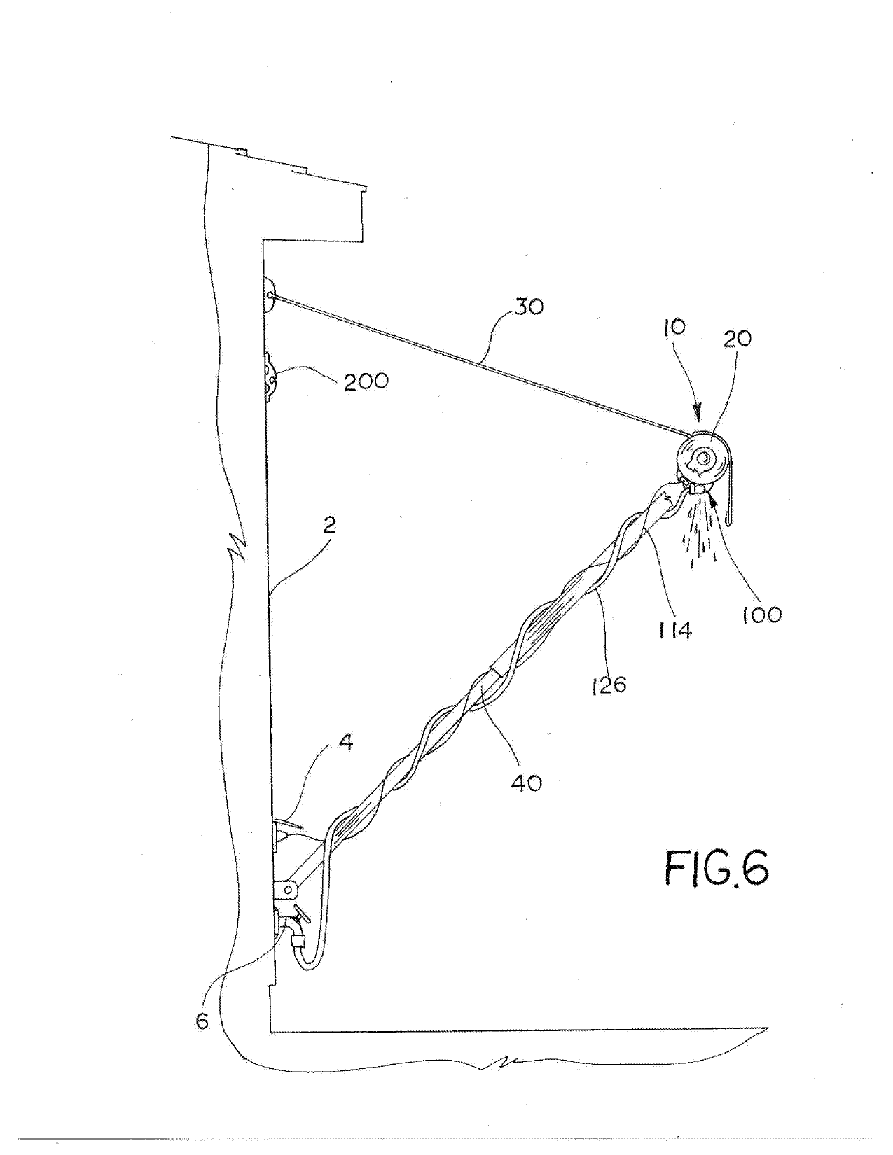

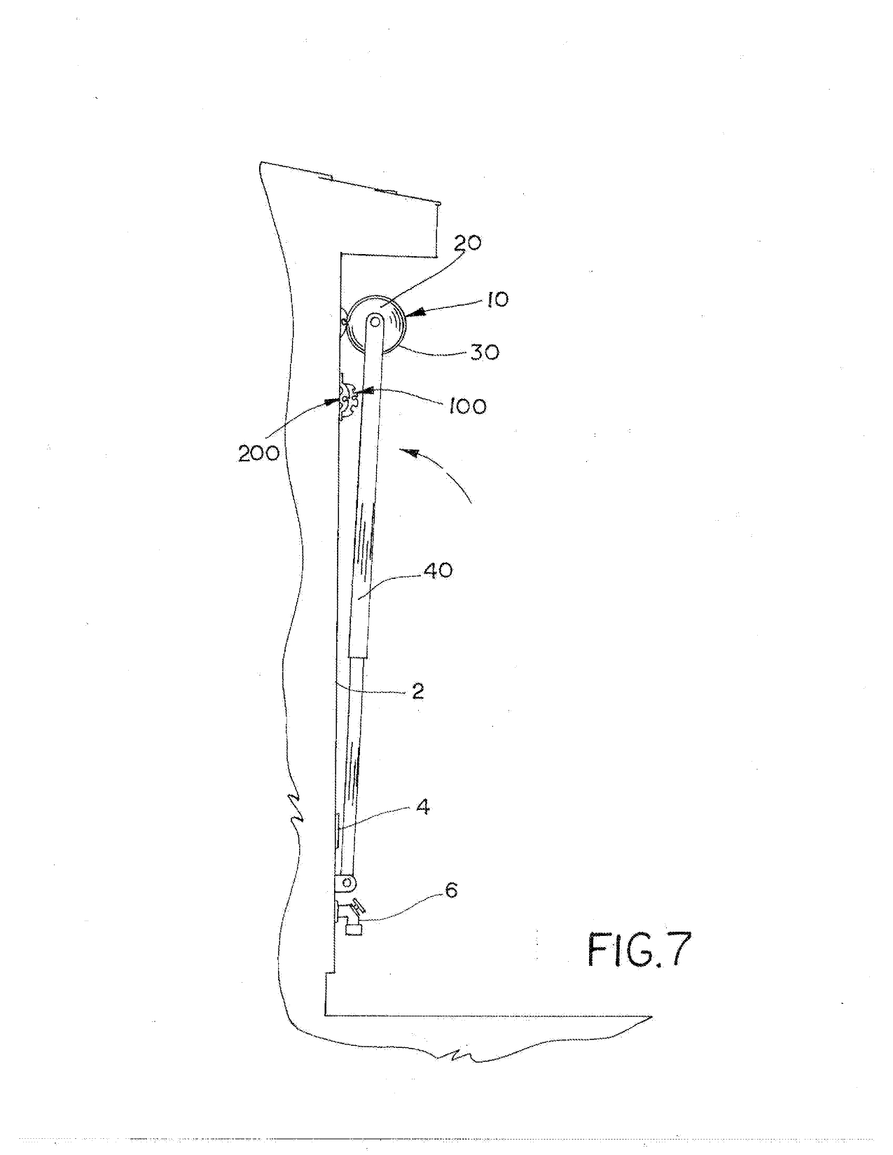

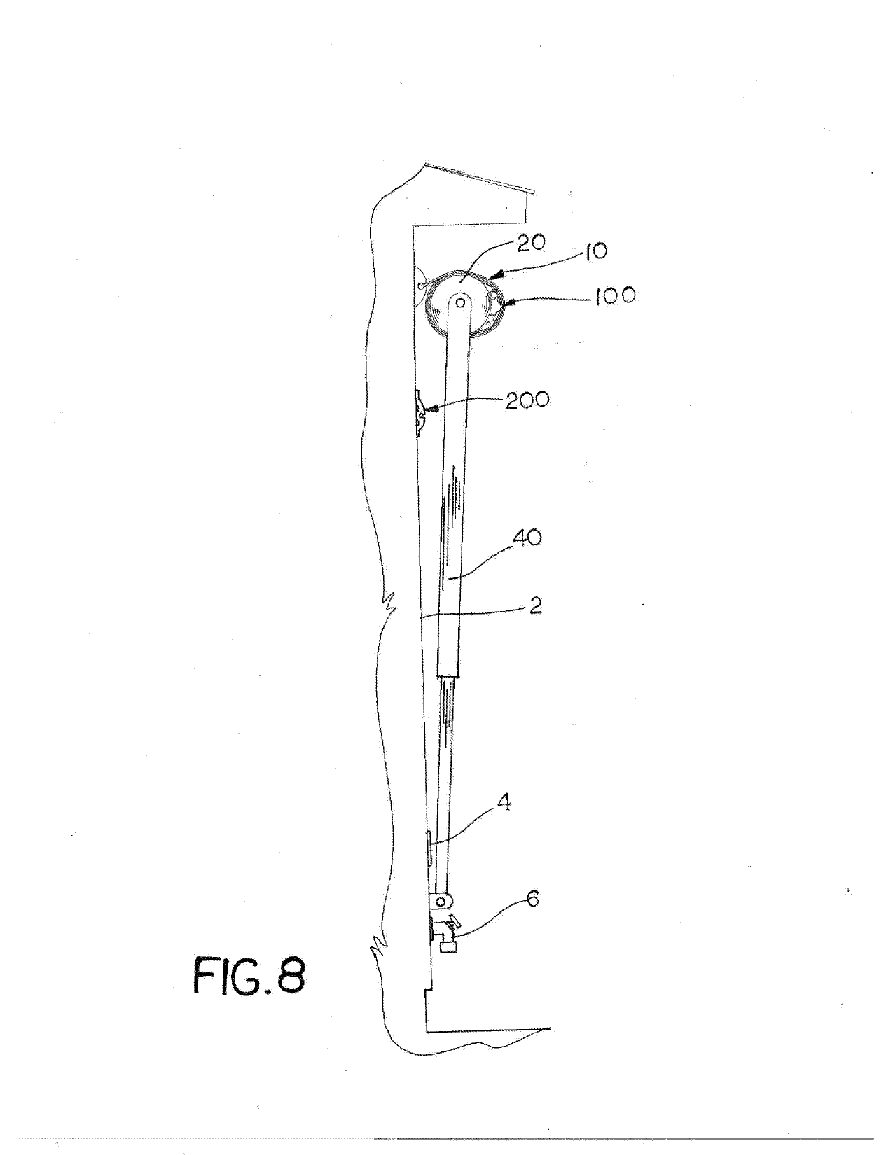

As shown, retractable awning 10 is attached or mounted to a structure 2, such as the side wall 2 of a recreational vehicle in this instance. Retractable awning 10 includes a roll assembly 20, a fabric covering 30 wound around a roll assembly 20 and a pair of telescoping support arms 40 (shown in FIGS. 6 and 7 only) that support the roll assembly. Roller tube assembly 20 includes an awning roll tube 22, which houses the internal components of the assembly, such as the drive shaft 28 and torsion spring (not shown). Roll tube 22 is typically made from a rolled or extruded metal, such aluminum. Roll tube 22 has a pair of longitudinal grooves or channels 33, which facilitate the connection of covering 30 to roll tube 32. As shown in FIG. 3. Cover 30 is typically held to roll tube 22 by rods 23, that are seated within grooves over cover 30, which is also seated within the grooves. Roller tube 22 has an additional longitudinal groove 25, which is commonly used for mounting auxiliary items to roll tube 22. Roll assembly 20 is support by support arms 40, which are pivotally connected to side wall 2 for movement between a rolled out (deployed) position (FIG. 6) and a rolled up (storage) position (FIGS. 7 and 8).

### Attachment

Awning roll attachment 100 has an elongated body 102, which houses an internal illumination system 110 and an internal misting system 120. Attachment body 102 generally is constructed from a formed or extruded plastic or composite material. Attachment body 102 has a concave rear face 103, which conforms generally to the curvature of the outer diameter of roll tube 22. An attachment tab 104 extends from rear surface 103 and runs the length of attachment body 102. Attachment tab 104 allows roll attachment 100 to be secured to roll tube 22 using a press fit connection. Attachment tab 104 terminates in a bulbous head 105 that is shaped and dimensioned to restrictively fit into auxiliary groove 25 of roll tube 22 (FIGS. 1 and 3). Attachment body 22 also has a longitudinal auxiliary groove 109 formed in its outer face that runs its entire length. Similar to auxiliary groove 25 of roll tube 22, auxiliary groove 109 allows other items to be connected to roll attachment 100 when it is connected to roll tube 20.

As shown in FIG. 3, illumination system 110 includes a strip of light emitting diodes 112 (LED light strip) or rope light (not shown) that is seated within a longitudinal channel 111 formed in attachment body 102. LED light strip 112 is visible through a longitudinal slot 113 that opens into channel 111. In alternative embodiments of attachment 100, attachment body 102 may be made from a transparent plastic that allows LED light strip 112 to be visible therethrough, without slot 113. LED strip 112 is a plurality of light emitting diodes wired together and embedded in a flat rectangular body of a transparent or translucent polymer material. Such LED light strips are common and well known in the electrical arts. LED light strip 112 includes a power cord 114 that extends from one end of the strip at the end of attachment 100. LED light strip 110 may also include various other electrical components and circuitry, which are not illustrated or described herein, but which are necessary for the desired operation of illumination system 110 and readily understood by those in the electrical arts. As shown in FIG. 6, power cord 114 may be connected to an external power outlet 4 in the sidewall 2 of the recreational vehicle and wrapped around or otherwise secured to support arms 40, when awning 10 is in the rolled out position.

Also shown in FIG. 3, misting systems 120 includes a plurality of misting nozzles 122 that are tapped into bores in attachment body 102. Nozzles 122 are in open communication with an internal fluid passage 121 formed in attachment body 102 that runs its entire length. Nozzles 122 are of conventional design and well know in the arts. Typically, nozzles 122 have a threaded body that allow them to be readily turned into threaded bores in attachment body 102. A connection fitting 124 is connected to fluid passage 121 at one end of attachment body 102. An end plug (not shown) closes fluid passage 121 at the opposite end of attachment body 102. A hose 126 connects the water supply 6 from the recreation vehicle to misting system 120 via connection fitting 124. Connection fitting 124 and hose 126 may take any form or configuration, which allows the connection of an external water supply to misting system 120 inside attachment body 102.

As shown in FIG. 6, awning roll attachment 100 is connected to roll tube 22 when awning 10 is in its deployed position. Once connected to roll tube 22, power cord 114 and hose 126 can be quickly connected and disconnected from awning roll attachment 100. As shown, awning roll attachment 100 may remain connected to roll tube 22 when the awning 10 is rolled up into its storage position (FIG. 8) or may be completely detached from roll tube 22 before the awning is rolled up (FIG. 7). If left in place, the awning cover 30 simply wraps around roll tube 22 and awning roll attachment 100.

### Mounting Bracket

FIGS. 4-7 show two storage mounting brackets 200, which securely hold awning attachment 100 to sidewall 2 of the recreational vehicle, providing a convenient storage mechanism for the attachment when not in use. Brackets 200 are constructed from a formed or extruded plastic or composite material, but may also be constructed from rolled or extruded metals, such as aluminum. Although two separate brackets are illustrated in the drawings, a single elongated bracket or additional shorter brackets may be used in other embodiments within the teachings of this invention. As shown, brackets 200 have a convex outer face 202 and two opposed flat flanges 204. The curvature of convex outer face 202 is generally the same as the outer diameter of roll tube 22. Mounting brackets 200 are affixed to sidewall 2 of the recreational vehicle by screws or other fasteners that extend through flanges 204. Brackets 200 may also be affixed to sidewall 2 by adhesives or other suitable means. Brackets 200 also have a longitudinal attachment groove 205 formed in their outer face that runs their entire length. As shown, attachment groove 205 receives attachment tab 104 of awning attachment 100 in a press fit engagement to securely hold the awning attachment to sidewall 2 of the recreational vehicle.

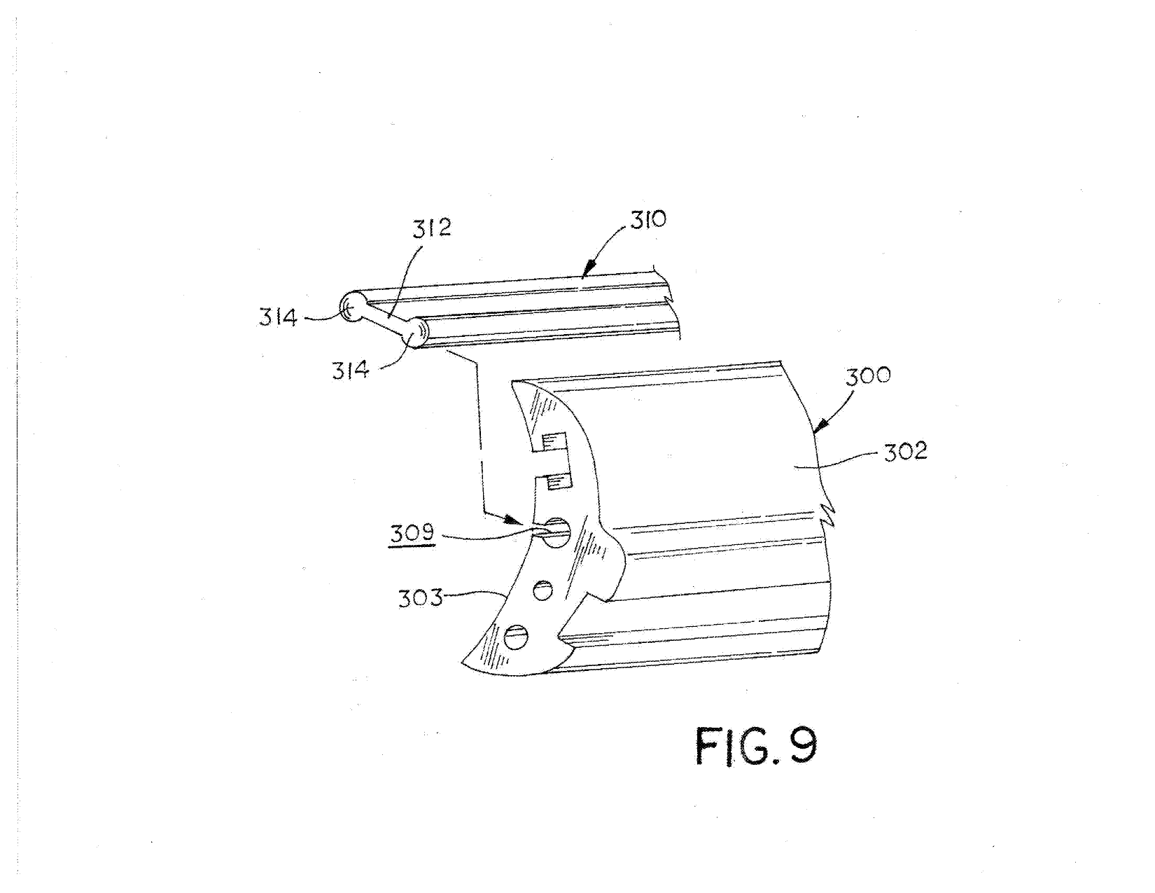

FIG. 9 illustrates an alternative embodiment of the awning roll attachment of this invention, which is designated generally as reference numeral 300. Roll Attachment 300 is identical in configuration and construction to roll attachment 100 described above, except that a separate connecting member 310 is used to secure roll attachment 300 to the awning roll. As shown, the concave rear face of attachment body 302 has longitudinal groove or channel 309, which is similar in configuration and function as grooves 33 in roll tube 22. Connection member 310 is an elongated member having a flat band 312 that terminates along opposite sides in a bulbous head 314. When connecting awning roll attachment 300 to a roll tube (not shown in FIG. 9), connection member heads 314 are seated within channel 309 of awning roll attachment 300 and grooves 33 of roll tube 22 in a secure press fit connection. One skilled in the art will note that one or more connection members 310 may be used to secure awning roll attachment 300 to either roll tube 22 or to a mounting bracket 200 as desired. In addition, the length of connection members 310 may vary as desired. For example, a single elongated connection member that extends substantially the length of the awing roll attachment 300 may be used to secure the attachment to roll tube 22, while multiple shorter connection members may be used for the same purpose.

One skilled in the art will note that the combination of the awning attachment and storage mounting bracket of this invention provides a convenient and aesthetically clean appearance to the retractable awning, while also providing illumination and misting. The awning attachment eliminates dangling cords and waterlines along with the clips and hangers used to support those cords and waterlines from the roll tube. The storage mounting brackets provide a convenient and readily accessible storage mechanism. The mounting brackets allow the awning attachment to be stored against a sidewall, so that the storage of the attachment does not occupy other valuable storage space. The press fit connection allows the awning attachment to quickly mount to any conventional roll tube, as well as the storage mounting brackets. In addition, the additional auxiliary groove in the awning attachment allows other items, such as mosquito screens, valances and other lighting fixtures to be simultaneously hung from the attachment, thereby maintaining the original functionality of the retractable awning.

The embodiment of the present invention herein described and illustrated is not intended to be exhaustive or to limit the invention to the precise form disclosed. It is presented to explain the invention so that others skilled in the art might utilize its teachings. The embodiment of the present invention may be modified within the scope of the following claims.

I claim:

1: An attachment for a retractable awning that includes a roll tube having a longitudinal auxiliary groove, the attachment comprising:
an elongated attachment body having a connection part adapted for restrictively seating with the auxiliary groove of the roll tube to secure the attachment body to the roll tube; and
misting means embedded within the attachment body for providing mist from the attachment body.

2: The attachment of claim 1 and illumination means embedded within the attachment body for providing illumination from the attachment body

3: The attachment of claim 1 wherein the attachment body has a concave rear face which abuts longitudinally against the roll tube.

4: The attachment of claim 3 wherein the connection part includes a tab extending outward from the rear face of the attachment body, which is restrictively received within the auxiliary groove of the roll tube when the attachment body is secured to the roll tube.

5: The attachment of claim 2 wherein the attachment body has a longitudinal channel formed therein, the channel extending substantially the length of the attachment body, the illumination means includes a light strip seated within the channel.

6: The attachment of claim 1 wherein the attachment body has an internal longitudinal fluid passage formed therein, the fluid passage extending substantially the length of the attachment body and forming part of the misting means.

7: The attachment of claim 6 wherein the misting means includes a plurality of nozzles connected to the attachment body in fluid communication with the fluid passage.

8: The attachment of claim 6 wherein the misting means includes a connection fitting connected to the attachment body in fluid communication with the fluid passage, the connection fitting adapted for connection to an external fluid source for supplying fluid to the misting system.

9: In combination, an attachment for a retractable awning roll that includes a roll tube having a longitudinal auxiliary groove, and a storage mounting bracket for securing the attachment to a wall,
the attachment includes an elongated attachment body having a connection part adapted for restrictively seating within the auxiliary groove of the roll tube to secure the attachment body to the roll tube, illumination means embedded within the attachment body for providing illumination from the attachment body, and misting means embedded within the attachment body for providing mist from the attachment body,
the mounting bracket is adapted for mounting to the wall and has a longitudinal groove defined therein, the groove of the mounting bracket adapted for restrictively receiving the connection part of the attachment to secure the attachment to the wall.

10: The combination of claim 9 wherein the attachment body has a concave rear face which abuts against longitudinally the roll tube.

11: The combination of claim 10 wherein the connection part includes a tab extending outward from the rear face of the attachment body, which is restrictively received within the auxiliary groove of the roll tube when the attachment body is secured to the roll tube.

12: The combination of claim 9 wherein the attachment body has a longitudinal channel formed therein, the channel extending substantially the length of the attachment body.

13: The combination of claim 12 wherein the illumination means includes a light strip seated within the channel.

14: The combination of claim 9 wherein the attachment body has an internal longitudinal fluid passage formed therein, the fluid passage extending substantially the length of the attachment body and forming part of the misting means.

15: The combination of claim 14 wherein the misting means includes a plurality of nozzles connected to the attachment body in fluid communication with the fluid passage.

16: The combination of claim 15 wherein the misting means includes a connection fitting connected to the attachment body in fluid communication with the fluid passage, the connection fitting adapted for connection to an external fluid source for supplying fluid to the misting system.

17: An attachment for a retractable awning that includes a roll tube having a longitudinal auxiliary groove, the attachment comprising:
an elongated attachment body having a connection part adapted for restrictively seating within the auxiliary groove of the roll tube to secure the attachment body to the roll tube; and
illumination means embedded within the attachment body for providing illumination from the attachment body

18: The attachment of claim 17 wherein the attachment body has a concave rear face which abuts longitudinally against the roll tube.

19: The attachment of claim 17 wherein the connection part includes a tab extending outward from the rear face of the attachment body, which is restrictively received within the auxiliary groove of the roll tube when the attachment body is secured to the roll tube.

20: The attachment of claim 17 wherein the attachment body has a longitudinal channel formed therein, the channel extending substantially the length of the attachment body, the illumination means includes a light strip seated within the channel.
